(19) United States
(12) Patent Application Publication
(10) Pub. No.: US 2023/0278574 A1
(43) Pub. Date: Sep. 7, 2023

(54) ONBOARD HAZARD DETECTION SYSTEM FOR A VEHICLE

(71) Applicant: CEPTION TECHNOLOGIES LTD., Jerusalem (IL)

(72) Inventors: Yossef Israel BUDA, Klar-Adumim (IL); Tal ISRAEL, Mazkeret-Batya (IL)

(73) Assignee: CEPTION TECHNOLOGIES LTD., Jerusalem (IL)

(21) Appl. No.: 18/018,059

(22) PCT Filed: Jul. 28, 2021
(86) PCT No.: PCT/IL2021/050909

§ 371 Date: Jan. 26, 2023

Related U.S. Application Data
(60) Provisional application No. 63/057,363, filed on Jul. 28, 2020.

(51) Int. Cl. B60W 50/14; B60W 30/09; B60W 30/095; B60W 30/18; B60W 40/076; G06V 20/56

(52) U.S. Cl. CPC B60W 50/14; B60W 30/09; B60W 30/0956; B60W 30/18036; B60W 40/076; G06V 20/56; B60W 2050/143; B60W 2050/146; B60W 2300/125; B60W 2552/15; B60W 2552/50; B60W 2554/80; B60W 2556/40

(57) ABSTRACT

An onboard hazard detection system for installing on a vehicle includes a processor that is configured to receive sensed data that is acquired by one or more sensors that are installed on the vehicle and that are configured to sense a topography of a region in the vicinity of the vehicle. The received data is analyzed to generate a three-dimensional map of the region based on the sensed data. One or more characteristics of an approach of the vehicle toward a cliff or safety barrier is calculated, based on the sensed data. The system detects when the calculated characteristics are indicative of a hazard and performs an action.

### FIELD OF THE INVENTION

The present invention relates to vehicle guidance. More particularly, the present invention relates to a vehicle onboard system for detecting safety hazards.

### BACKGROUND OF THE INVENTION

In both mining and construction sites, it is a common practice to load excavated dirt, rock, and other waste materials onto trucks or other vehicles for removal. In many cases, the vehicles dump the materials over a cliff into a natural or manmade depression in the ground. The vehicle generally approaches the cliff while travelling in reverse, such that the vehicle operator’s view of the approach to the cliff may be partially obstructed by the rear portion of the vehicle. It may also be noted that repeated trips back and forth between a loading point, where material is loaded onto the vehicle, and the cliff where the material is to be dumped, may become monotonous to the operator of the vehicle.

At a properly maintained site, an elongated mound, or berm, or another similar barrier, is erected along the cliff. Typically, the barriers are formed by tractors or other earthmoving equipment by piling dirt, gravel, or other material that is found on the ground near the cliff, to form the barrier. Such a system of barriers typically requires constant or frequent maintenance. For example, the barrier may degrade over time by loss of the typically loose material from the barrier. Such loss of material may be caused by repeated contact of trucks with the barrier, removal of material by wind, rain, or other effects of weather conditions, or other causes. Furthermore, due to filling of the depression by the dumping of material, or due to other changes in operations at the site, the trucks may be directed to dump material at varying locations along the cliff.

Typically, a barrier in the form of a berm is erected along the cliff to a height that is approximately half the height of the wheels of a truck or other vehicle. A width of the berm is typically at least twice its height.

When a vehicle approaches the berm or other barrier while travelling in reverse, the operator of the truck may feel the when the rear wheels of vehicle begin to ascend the barrier. The operator then knows to stop the vehicle and to begin dumping. A vehicle is typically expected to approach the vehicle perpendicularly to the barrier and at a sufficiently low speed to facilitate feeling the contact of the vehicle’s rear wheels with the barrier.

In the event that a barrier is not sufficiently high, a vehicle operator may have difficulty feeling when the vehicle contacts the barrier. Similarly, if the vehicle approaches the barrier too quickly, or at an oblique angle to the barrier, the operator of the vehicle may not identify when the vehicle contacts the barrier. In any such case, if the rear of the vehicle begins to cross the barrier to the side facing the cliff, the heavy weight of the vehicle may pull the vehicle over the edge of the cliff.

### SUMMARY OF THE INVENTION

There is thus provided, in accordance with an embodiment of the invention, an onboard hazard detection system for installing on a vehicle, the system including a processor that is configured to: receive sensed data that is acquired by one or more sensors that are installed on the vehicle and that are configured to sense a topography of a region in the vicinity of the vehicle; analyze the received data to: generate a three-dimensional map of the region based on the sensed data; calculate one or more characteristics of an approach of the vehicle toward a cliff or safety barrier, based on the sensed data; and detect when the calculated characteristics are indicative of a hazard; and when an indication of the hazard is detected, perform an action.

Furthermore, in accordance with an embodiment of the invention, the characteristics are selected from a group of characteristics consisting of: a speed of the vehicle toward the cliff or the safety barrier, an angle of approach of the vehicle toward the cliff or the safety barrier, a distance from the cliff or the safety barrier, and a time to impact with the cliff or the safety barrier.

Furthermore, in accordance with an embodiment of the invention, the processor is further configured to detect an obstacle based on the sensed data.

Furthermore, in accordance with an embodiment of the invention, the processor is configured to detect a defect in the safety barrier.

Furthermore, in accordance with an embodiment of the invention, the defect includes an insufficient height of the barrier or an insufficient width of the barrier.

Furthermore, in accordance with an embodiment of the invention, the processor is further configured to receive sensed data from one or more movement sensors that are configured to sense a characteristic of movement of the vehicle.

Furthermore, in accordance with an embodiment of the invention, the processor is configured to generate the map using the data received from the one or more movement sensors.

Furthermore, in accordance with an embodiment of the invention, the processor is further configured to receive data from one or more navigation sensors.

Furthermore, in accordance with an embodiment of the invention, the processor is configured to analyze the received sensed data only when the vehicle is within a predefined geographic region as indicated by the one or more navigation sensors.

Furthermore, in accordance with an embodiment of the invention, the processor is configured to analyze the sensed data only when the vehicle is travelling in reverse.

Furthermore, in accordance with an embodiment of the invention, the hazard is selected from a group of hazards consisting of: an unsafe speed of the approach, an unsafe angle of the approach, a defect in the safety barrier, an unsafe distance from the cliff, an unsafe distance from a downward slope, a negative slope in a surface, and presence of an obstacle.

Furthermore, in accordance with an embodiment of the invention, the action includes issuing a warning or controlling operation of the vehicle.

There is further provided, in accordance with an embodiment of the invention, a method of operation of an onboard hazard detection system installed on a vehicle, the method including: operating one or more mapping sensors that are installed on the vehicle and that are configured to sense a topography of a region in the vicinity of the vehicle; receiving sensed data that is acquired by the one or more mapping sensors; generating a three-dimensional map of the region based on the sensed data; calculating one or more characteristics of an approach of the vehicle toward a cliff or safety barrier, based on the sensed data; detecting when the calculated characteristics are indicative of hazard; and when an indication of the hazard is detected, performing an action.

Furthermore, in accordance with an embodiment of the invention, the method includes detecting an obstacle based on the sensed data.

Furthermore, in accordance with an embodiment of the invention, the method includes detecting a defect in the safety barrier.

Furthermore, in accordance with an embodiment of the invention, the method includes including receiving sensed data from one or more movement sensors that are configured to sense a characteristic of movement of the vehicle.

Furthermore, in accordance with an embodiment of the invention, generating the map further includes using the data received from the one or more movement sensors.

Furthermore, in accordance with an embodiment of the invention, the method includes receiving data from one or more navigation sensors.

Furthermore, in accordance with an embodiment of the invention, the characteristics are selected from a group of characteristics consisting of: a speed of the vehicle toward the cliff or the safety barrier, an angle of approach of the vehicle toward the cliff or the safety barrier, a distance from the cliff or the safety barrier, and a time to impact with the cliff or the safety barrier..

Furthermore, in accordance with an embodiment of the invention, the hazard is selected from a group of hazards consisting of: an unsafe speed of the approach, an unsafe angle of the approach, a defect in the safety barrier, an unsafe distance from the cliff, an unsafe distance from a downward slope, a negative slope in a surface, and presence of an obstacle.

Furthermore, in accordance with an embodiment of the invention, performing the action includes issuing a warning or controlling operation of the vehicle.

### BRIEF DESCRIPTION OF THE DRAWINGS

In order for the present invention to be better understood and for its practical applications to be appreciated, the following Figures are provided and referenced hereafter. It should be noted that the Figures are given as examples only and in no way limit the scope of the invention. Like components are denoted by like reference numerals.

FIG. 1A schematically illustrates a layout of site in which a hazard detection system operates, in accordance with an embodiment of the invention.

FIG. 1B schematically illustrates a side view of a site of operation of the hazard detection system shown in FIG. 1A.

FIG. 2 is a schematic block diagram of components of an example of a hazard detection system, in accordance with an embodiment of the invention.

FIG. 3 is a schematic block diagram illustration of an example of operation of the hazard detection system illustrated in FIG. 2.

FIG. 4 is a flow chart depicting a method of operation of the hazard detection system illustrated in FIG. 2.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer’s registers and/or memories into other data similarly represented as physical quantities within the computer’s registers and/or memories or other information non-transitory storage medium (e.g., a memory) that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, the conjunction “or” as used herein is to be understood as inclusive (any or all of the stated options).

Some embodiments of the invention may include an article such as a computer or processor readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein.

In accordance with an embodiment of the invention, an onboard hazard detection system is configured for installation on a vehicle, such as a dump truck, that may be operated to approach a cliff while travelling in reverse. When the vehicle travels in reverse, the system may operate to monitor the reverse travel. In some cases, the system may monitor reverse travel only when the vehicle is currently operating within one or more regions in which a cliff is present.

The system is configured to detect one or more types of hazards when a vehicle travels in reverse toward the cliff. A hazard may include, for example, lack of a safety barrier (e.g., a berm) or a defective barrier, approaching the cliff or barrier at an unsafe speed, approaching the cliff or barrier at an unsafe angle, approaching too close to the cliff, a downward slope, or another hazard. When a hazard is detected, an appropriate warning is conveyed to an operator of the vehicle.

The system may also be applied in some situations that do not necessarily involve the risk of falling off cliffs, for example, when backing toward a hopper or approaching a stockpile.

The system that is installed on the vehicle includes one or more sensors. For example, the sensors may include mapping sensors that are configured to sense a topography of an environment of the vehicle, movement sensors to sense parameters that characterize travel of the vehicle, and navigation sensors that sense a location or direction of travel of the vehicle. Some of the sensors may be installed on the vehicle as part of installation of the hazard detection system on the vehicle. Other sensors may have been preinstalled onto the vehicle, e.g., by a manufacturer of the vehicle as standard or optional equipment, or otherwise. It should be noted that the division of sensors into mapping sensors, movement sensors, and navigation sensors is for convenience of the discussion only, and that a single sensor may provide sensed data that may be utilized for more than one purpose.

Mapping sensors may include, for example, one or more sensors for imaging or otherwise detecting a topography of an environment of the vehicle, in particular, behind the vehicle. For example, one or more cameras or other imaging devices (e.g., operating in the visible, infrared, or other spectral range) may acquire video or single-frame images of a region within viewing range of the imaging device. For example, a vehicle may include an imaging device that acquires images of a region behind the vehicle. One or more other rangefinder sensors, e.g., employing lidar, radar, ultrasound, or another type of wave, may detect a distance to surfaces of the topography surrounding the vehicle. Where the rangefinder sensor is a scanning sensor, the sensor may produce a three-dimensional map of nearby surfaces. (As used herein, topography refers to the locations, and, in some cases, orientations, of surfaces that are detectable, whether surfaces of the terrain, or of manmade objects or structures.)

Movement sensors may be configured to sense one or more of a speed of travel (e.g., via the speedometer of the vehicle, a Global Navigation Satellite System (GNSS) receiver, Doppler radar, or another sensor that is configured to measure a speed of the vehicle), a direction of travel (e.g., via a gyroscope, compass, GNSS, or other device), a steering angle (e.g., by steering angle sensor), an acceleration or deceleration (e.g., by an accelerometer, inertial measurement unit (IMU), or other device), a distance travelled (e.g., by an odometer or GNSS), a change in direction of travel (e.g., by an IMU, or other device), a slope of travel (e.g., by a tilt sensor, IMU, or other device), or other sensor that may measure a parameter that characterizes travel of the vehicle.

Navigation sensors may include one or more sensors or aids that enable determination of a position, orientation, direction of travel, or other parameters that characterize one or more of a current position, direction of travel, speed of travel, or other characteristic of travel of a vehicle. For example, navigation sensors may include one or more of a GNSS receiver, an IMU (which may function one or both of a movement sensor and a navigation sensor), a gyroscope, a compass, a tilt sensor, or another sensor that may characterize a location and direction of travel of the vehicle in two or three dimensions.

The system includes a processor that is configured to operate in accordance with programmed instructions to receive sensed data from the sensors, and to analyze the received data. The analysis of the data may yield one or more of: a speed of approach toward a barrier, a distance from the barrier, a time to impact with the barrier, and angle of approach to the barrier, a height and width of the barrier, a distance to a cliff (e.g., in the event that a barrier is malformed or non-existent). In some cases, the processor may be configured to detect, and identify in some cases, an obstacle.

For example, the processor may be configured to analyze the sensed data and generate a three-dimensional map of a region that is in the vicinity of, and that is above, a cliff. Continued analysis of the data may detect characteristics of travel of the vehicle in approaching the cliff. In some cases, analysis of characteristics of the travel may detect a hazard in the approach to the cliff. The hazard may include an approach to the cliff, or toward a safety barrier between the vehicle and the cliff, that at an unsafe speed, at an unsafe angle of approach, that is too near to the edge of the cliff, that a safety barrier is defective, that an obstacle is present along a currently projected route toward the cliff, or another hazard.

When a hazard is detected, the processor may issue an appropriate warning. The warning may be sent to a user interface that is configured to convey information to an operator of the vehicle. For example, the user interface may include one or more visual output devices (e.g., display screens, indicator lights, or other visual output devices), one or more audible output devices (e.g., speakers, alarms, or other devices) for conveying a warning (or other information) to an operator of the vehicle. In some cases, the processor may calculate a recommended or corrected approach route toward the cliff, and may communicate instructions for driving along the route to the vehicle operator via the user interface.

In some cases, the system may be configured to transmit data to a controller or other external device. For example, data that is transmitted to a central controller may be reviewed by an operator of the site, e.g., to monitor maintenance of the site or to monitor the competence or behavior of operators of the vehicles. In some cases, instructions for driving the vehicle along a recommended route may be transmitted to a system for autonomous operation of the vehicle.

A hazard detection system as described herein may be advantageous over other methods of guiding a vehicle in the vicinity of a cliff. It may be noted that at many mining and construction sites, travel near dump sites may be dusty, such that the views of some types of cameras may be obscured. The fields of view of typical backup features, such as rear-facing cameras, proximity sensors, and rearview mirrors may not be situated to sense berms or cliffs. In some cases, the typical rough terrain near a cliff may introduce so much noise as to render a typical warning system useless. Thus, despite various technological advancements in the field, backing a vehicle toward a cliff often relies on the operator’s situational awareness and ability to feel the cliff edge themselves.

On the other hand, a hazard detection system as described herein may sense a berm or a cliff while the vehicle is at a safe distance from the cliff. Thus the system may warn a driver in a timely manner if the vehicle begins to approach the cliff in an unsafe manner (e.g., too quickly or at an unsafe angle). The timely warning may then encourage the driver to correct the course of the vehicle so as to safely and efficiently reach the position where a load is to be dumped.

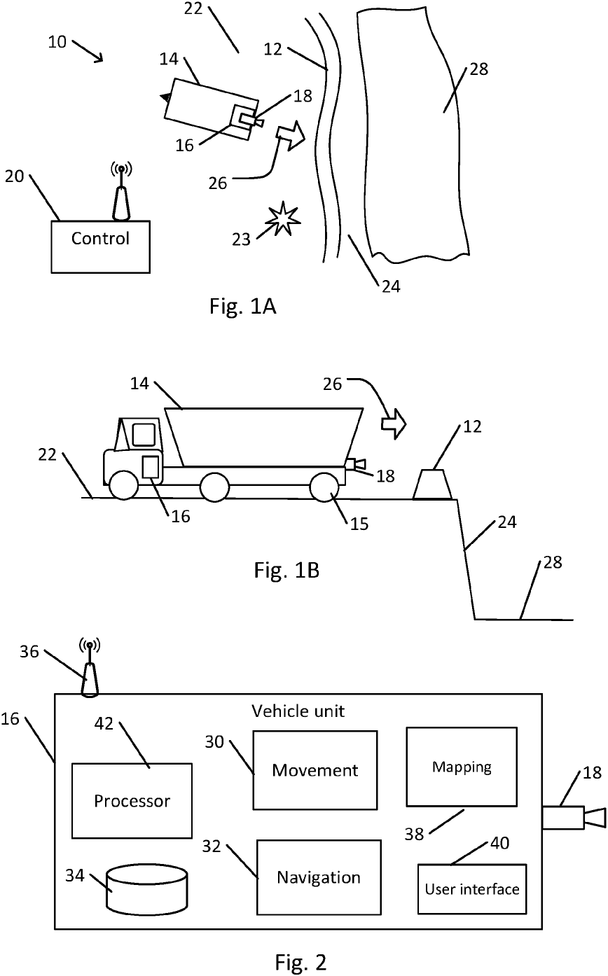

FIG. 1A schematically illustrates a layout of site in which a hazard detection system operates, in accordance with an embodiment of the invention. FIG. 1B schematically illustrates a side view of a site of operation of the hazard detection system shown in FIG. 1A.

Onboard hazard detection system 16 is configured to be installed in one or more vehicles 14 that operate at a site 10. Various components of onboard hazard detection system 16 may be installed at one or more locations on vehicle 14, as described below. A typical site 10 may include a mining site or construction site. In particular, onboard hazard detection system 16 is configured to operate at a site 10 that includes an upper roadway 22, on which a vehicle 14 may travel, and a cliff 24 toward which vehicle 14 may be required to travel, typically in reverse, as indicated by arrow 26.

Typically, vehicle 14 is a dump truck or other vehicle that may be operated transport material to cliff 24, and dump the transported material over cliff 24 onto a lower level 28. Typically, lower level 28 may represent a topographical pit, valley, gorge, or other depression, either natural or manmade (e.g., a previously excavated mining pit), into which the material is to be dumped (e.g., either to dispose of the material or to raise the height of lower level 28).

Although the discussion herein refers to vehicles that travel in reverse to toward a cliff 24 to dispose of a load of transported material, onboard hazard detection system 16 may be operated in any type of vehicle, travelling forward or in reverse, in the vicinity of a cliff 24 or other detectable hazard (e.g., a downward slope, a body of water, a field of sharp or otherwise potentially hazardous objects, or other hazard).

In some cases, a safety barrier 12 is arranged on upper roadway 22 adjacent to cliff 24. For example, safety barrier 12 may include a berm of loose material, such as soil, gravel, stones, or other material that is found on or near the surface of upper roadway 22, that is heaped into an elongated mound along cliff 24. The height and width of a typical safety barrier 12 are designed such that when one or more rear tires 15 of vehicle 14 encounter safety barrier 12 when travelling in reverse, rear tires 15 begin to ascend safety barrier 12. When rear tires 15 ascend safety barrier 12, the resulting forward tilt of vehicle 14 is expected to be noticeable by an operator of vehicle 14. However, repeated encounters of vehicles 14 with safety barrier 12, or other factors, may degrade (e.g., lower the height of or interrupt the continuity of) safety barrier 12 in the absence of timely maintenance activity.

Onboard hazard detection system 16 is configured to operate one or more sensors, including one or more imaging devices 18, to monitor the approach of vehicle 14 toward cliff 24. For example, onboard hazard detection system 16 may monitor one or more of a speed of approach of vehicle 14 toward cliff 24, an angle of approach, a condition of safety barrier 12, a distance from safety barrier 12 or cliff 24, or another characterization of the approach of vehicle 14 toward cliff 24.

Onboard hazard detection system 16 may also be configured to detect one or more types of obstacles 23 that are present on upper roadway 22. For example, an obstacle 23 may include a natural or manmade, stationary or moving, rise (e.g., boulder, heap or pile, vehicle, person, animal, structure, equipment, or other surface or object that rises above the surface of upper roadway 22 and could interfere with travel of vehicle 14 on upper roadway 22), depression (e.g., pit, sinkhole, pothole, puddle, crack, fissure, or other depression below the surface of surface of upper roadway 22 that could interfere with travel of vehicle 14 on upper roadway 22 or be indicative of hazardous conditions), a disrupted surface of upper roadway 22 (e.g., sharp projections, loose earth, or other conditions that could interfere with travel on upper roadway 22), or other types of obstacles.

In some cases, onboard hazard detection system 16 may be configured to communicate with a controller 20 that is external to vehicle 14. For example, controller 20 may be associated with a supervisor of site 10, a maintenance crew that operates at site 10, a manager of a fleet of vehicles 14 that operate at site 10, or another party.

FIG. 2 is a schematic block diagram of components of an example of a hazard detection system, in accordance with an embodiment of the invention.

Onboard hazard detection system 16 includes a plurality of sensors that are configured to sense various characteristics of travel of vehicle 14 on upper roadway 22, especially when in the vicinity of cliff 24. Various sensors may be installed at various locations on vehicle 14, e.g., in accordance with the characteristics that each sensor is configured to sense. In some cases, onboard hazard detection system 16 may utilize or connect to one or more sensors that were installed on vehicle 14 prior to installation of onboard hazard detection system 16, either by a manufacturer of vehicle 14 or otherwise. For example, some vehicles 14 may include a rear-facing camera, proximity sensors, a GNSS receiver, an IMU, a lidar or radar system, or other types of sensors.

Onboard hazard detection system 16 includes a processor 42 that is installed on vehicle 14. unit. Processor 42 may include one or more intercommunicating computers or processing units that are configured to operate in accordance with programmed instructions. Processing units of processor 42 may include one or more processing unit that are installed specifically as part of the onboard hazard detection system 16, onboard computers that are built into the vehicle 14, or a processing unit (e.g., of a smartphone) that is associated with a driver or operator of vehicle 14.

Processor 42 may communicate with data storage 34 of onboard hazard detection system 16. Data storage 34 may include one or more volatile or nonvolatile, fixed or removable, local or remote, memory or data storage devices. Data storage 34 may be utilized to store, for example, programmed instructions for operation of processor 42, data or parameters for use by processor 42 during operation, or results of operation of processor 42.

Processor 42 may communicate with one or more other devices, such as another controller 20, another onboard hazard detection system 16, or another device or system via wireless communications 36 of onboard hazard detection system 16.

Sensors of onboard hazard detection system 16 typically include mapping sensors 38 that are configured to assist in mapping topography of an environment of vehicle 14. In particular, mapping sensors 38 may be configured to map the topography of a region behind vehicle 14. For example, mapping sensors 38 may include one or more imaging devices 18 that may acquire data that may be processed to produce a two- or three-dimensional map of the surroundings of vehicle 14. Typically, at least some of imaging devices 18 are directed rearward to acquire images of a field of view behind vehicle 14. For example, an imaging device 18 may include a video camera or a camera that acquires single frames. An imaging device 18 may include a stereo camera, a pair of single cameras, or other camera that is capable of acquiring three-dimensional imaging data that may be processed to yield three-dimensional data of the topography. An imaging device 18 may be configured to acquire images in the visible spectral range, in the infrared spectral range, or in another spectral range. An imaging device 18 may be stationary or movable, e.g., capable of being panned, tilted, or both.

Alternatively or in addition to imaging devices 18, mapping sensors 38 may include one or more rangefinder or surface detecting sensors that may be operated to produce a three-dimensional map of the topography, e.g., of surfaces or objects, that surround vehicle 14. For example, mapping sensors 38 may include a scannable lidar or radar device that is capable of determining a distance to a nearest surface as a function of direction.

In particular, mapping sensors 38 may be operated to locate a location of safety barrier 12 relative to vehicle 14. Mapping sensors 38 may be operated to map contours of safety barrier 12, which may be analyzed by processor 42 to determine a current height of safety barrier 12, to detect any gaps in safety barrier 12, or to otherwise detect any defects or degradation of safety barrier 12. Data from mapping sensors 38 may be analyzed by processor 42 to detect a negative slope behind vehicle 14, e.g., indicative of crossing safety barrier 12 or of cliff 24 in the absence of safety barrier 12.

Changes in topography that are detected by operating mapping sensors 38 as vehicle 14 travels in reverse toward safety barrier 12 may be analyzed by processor 42 to yield one or more of a speed of approach of vehicle 14 toward safety barrier 12 or cliff 24, an angle of approach of vehicle 14 toward safety barrier 12, or other characteristics of travel of vehicle 14 toward safety barrier 12 or cliff 24.

In some cases, sensors of onboard hazard detection system 16 may include one or more movement sensors 30 that are configured to sense one or more characteristics of, or parameters related to, movement of vehicle 14 as it travels on upper roadway 22, e.g., toward cliff 24. For example, movement sensors 30 may include one or more of a speedometer, odometer, accelerometer, steering angle sensor, IMU, brake sensor, tilt sensor, or other types of sensor that may operate to characterize operation or movement of vehicle 14. Some or all of movement sensors 30 may be original equipment that is preinstalled in vehicle 14 prior to installation of onboard hazard detection system 16. For example, onboard hazard detection system 16 may access or communicate with preinstalled movement sensors 30 via an onboard computer of vehicle 14, or otherwise. Alternatively or in addition, some or all of movement sensors 30 may be installed on vehicle 14 at the time of installation of onboard hazard detection system 16.

For example, movement sensors 30 may be operated to sense of speed of travel of vehicle 14, a change in tilt of vehicle 14 (e.g., due to one or more rear tires 15 ascending safety barrier 12 or descending toward cliff 24), an acceleration or deceleration of vehicle 14, a distance travelled by vehicle 14 (e.g., when approaching cliff 24), or other characteristics of travel or movement of vehicle 14.

Sensors of vehicle unit 16 may, in some cases, include one or more navigation sensors 32. Navigation sensors 32 may include one or more sensors or aids that enable determination of a position (e.g., in a local or global coordinate system), orientation, direction of travel, or other parameters that characterize one or more of a current position, direction of travel, speed of travel, or other characteristic of a travelling of vehicle 14, e.g., on upper roadway 22. For example, navigation sensors 32 may include one or more of a GNSS receiver, an IMU (which may function as one or both of a movement sensor 30 and a navigation sensor 32), a gyroscope, a compass, a tilt sensor, or another sensor that may characterize travel of vehicle 14 in two or three dimensions.

Processor 42 of onboard hazard detection system 16 may communicate with a user interface 40 of onboard hazard detection system 16. For example, user interface 40 may include one or more visual output devices (e.g., display screens, indicator lights, or other visual output devices), one or more audible output devices (e.g., speakers, alarms, or other devices) for communicating audibly verbal or nonverbal information, e.g., to an operator of vehicle 14. User interface 40 may include one or more components that were installed on vehicle 14 prior to installation of onboard hazard detection system 16. For example, onboard hazard detection system 16 may connect to an existing display screen in a cab of vehicle 14, an audio system of vehicle 14, or other equipment that may have been previously installed in vehicle 14.

In some cases, a display via a display screen of user interface 40 of a map or image of a region behind or near vehicle 14 may include markings that are generated by processor 42. The markings may indicate one or more of the positions of safety barrier 12, cliff 24, and any detected obstacles 23. The markings may indicate one or more boundaries of a region toward which vehicle 14 is traveling (e.g., indicative of the lateral sides of vehicle 14, regions ahead of rear tires 15 or other tires of vehicle 14, or otherwise mark boundaries).

For example, when processor 42 determines that an approach of vehicle 14 toward safety barrier 12 or cliff 24 is potentially hazardous, e.g., too fast or too great an angle, processor 42 may generate a warning that may be conveyed to an operator of vehicle 14 via user interface 40.

In some cases, user interface 40 may include one or more input devices for inputting commands or data (e.g., acknowledging a warning or alert, overriding activation module 44, as described below, to initiate monitoring by onboard hazard detection system 16, or other input data). For example, input devices may include a touchscreen, a voice control system, or a manually operable control.

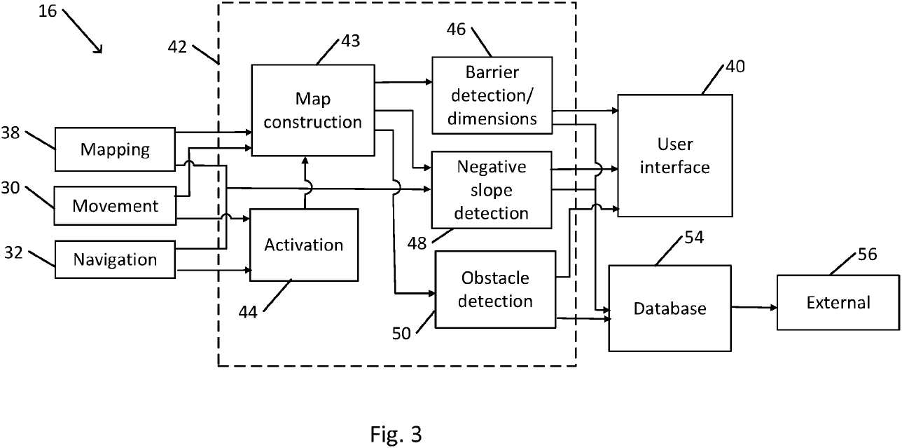

FIG. 3 is a schematic block diagram illustration of an example of operation of the hazard detection system illustrated in FIG. 2.

In the example shown, a map construction module 43 executing on processor 42 may receive sensor data from mapping sensors 38. Map construction module 43 is configured to generate a three-dimensional map of the area behind vehicle 14 using data that is received from mapping sensors 38.

In some cases, data from mapping sensors 38 alone may be insufficient to generate the three-dimensional map. For example, an imaging device 18, a lidar scanner, or other sensor of mapping sensors 38 may have a limited field of view or scanning range, or may otherwise be unsuitable for collecting sufficient data to enable map construction module 43 to build a three-dimensional map. In this case, map construction module 43 may be configured to combine data regarding movement of vehicle 14 from movement sensors 30 (e.g., from an IMU, speedometer, odometer, steering angle sensor, or other sensor of movement sensors 30) with data from mapping sensors 38 to generate the three-dimensional map. For example, map construction module 43 may apply one or more visual simultaneous localization and mapping (VSLAM) techniques, structure from motion (SFM) techniques, or other techniques to combine data from mapping sensors 38 with data from movement sensors 30, which sense concurrent motion of vehicle 14, to generate the three-dimensional map. The three-dimensional map may be stored in data storage 34 of onboard hazard detection system 16.

In some cases, an activation module 44 operating on processor 42 may determine whether onboard hazard detection system 16 is to operate to detect hazards.

For example, activation module 44 may receive data from navigation sensors 32 (e.g., GNSS or other sensor) and analyze the data to determine if a current geographic location of vehicle 14 is within a predefined geographic region. For example, the geographic region may include a dumping region, e.g., near a cliff 24 or another potential hazard (e.g., an obstacle 23 or other hazard), or if vehicle 14 is within a predefined distance of a cliff 24 or other hazard whose geographic location is known (e.g., in a local or global coordinate system). In some cases, activation module 44 may receive data from movement sensors 30, e.g., to determine when vehicle 14 is travelling in reverse.

For example, activation module 44 may instruct other modules of onboard hazard detection system 16 (e.g., map construction module 43 described below) to analyze data from mapping sensors 38 or movement sensors 30 only when one or more conditions are met. The conditions may include vehicle 14 being located in a predefined geographical region (e.g., that is known to include one or more of a cliff 24, safety barrier 12, or obstacle 23), when vehicle 14 is travelling in reverse, or another condition.

In some cases, onboard hazard detection system 16 may be configured such that an operator of vehicle 14 may manually override activation module 44 to activate operation of one or more modules of onboard hazard detection system 16 when one or more of the conditions are not met.

Barrier detection module 46, executing on processor 42, may analyze the three-dimensional map generated by map construction module 43 (which may utilize sensed data from mapping sensors 38 and movement sensors 30) to detect any safety barriers 22 (e.g., berms or other barriers) that are represented in the three-dimensional map. For example, barrier detection module 46 may apply one or more object recognition techniques to identify any structures within the three-dimensional map. In some cases, an algorithm for identifying a representation of a safety barrier 12 in the three-dimensional map may be developed using machine learning or training techniques, such as regression analysis or random sample consensus (RANSAC), or other methods that may be applied to detect anomalies or abnormalities in a surface.

Barrier detection module 46 may be configured to calculate one or more of height, width, slope, or other dimension or characteristic of a detected safety barrier 12.

Barrier detection module 46 may calculate a distance between vehicle 14 and a detected safety barrier 12, and an angle between vehicle 14 and safety barrier 12 (e.g., between a longitudinal axis of vehicle 14 and a section of safety barrier 12 toward which vehicle 14 is travelling in reverse. Barrier detection module 46 may utilize the calculated distance, as well as data from movement sensors 30, to calculate a time of impact of a rear end (e.g., rear tire 15) of vehicle 14 with safety barrier 12. Similarly, barrier detection module 46 may calculate a rate of approach of vehicle 14 toward safety barrier 12.

In some cases, barrier detection module 46 (or another module that utilizes results of analysis by barrier detection module 46) may calculate a predicted path of movement of based on data from movement sensors 30 (e.g., a detected current steering angle of vehicle 14 or other data). In some cases, barrier detection module 46 (or another module that utilizes results of analysis by barrier detection module 46) may calculate an optimal path of approach of vehicle 14 toward safety barrier 12. In some cases, the calculation of the optimal route may include calculating a route that avoids any obstacles 23 that are detected by obstacle detection module 50.

If, when a current approach toward safety barrier 12 is determined by barrier detection module 46 to be unsafe (e.g., too fast, angle of approach too oblique, or otherwise), e.g., as compared with predefined safety criteria, barrier detection module 46 may issue an alert. The alert may be conveyed to an operator of vehicle 14 via user interface 40 of onboard hazard detection system 16.

Barrier detection module 46 may be configured to record an actual route that is traveled by a vehicle 14 when travelling toward or near cliff 24.

Results of operation of barrier detection module 46, or of a module of onboard hazard detection system 16 that utilizes calculations of barrier detection module 46, may be recorded in database 54. For example, onboard hazard detection system 16 may record sensed data or results of analysis in a database, e.g., of controller 20 (e.g., on-site or cloud storage). The data may be reviewed by one or more parties (e.g., maintenance team, vehicle supervisors, or other parties, in order to track conditions on site 10 or on upper roadway 22, e.g., a state of safety barrier 12. Stored data may be reviewed to review operational patterns and behavior such as driving behavior.

In some cases, the data (e.g., as well as data from operation of negative slope detection module 48 or obstacle detection module 50, as described below) may be transmitted to an external system 56. For example, external system 56 may include a system for autonomous operation of vehicle 14, e.g., either in general or only during dumping operations.

Negative slope detection module 48 executing on processor 42 may apply algorithms or methods similar to those of map construction module 43, or other methods to the three-dimensional map, as well as to data received from mapping sensors 38 (which may utilize sensed data from mapping sensors 38 and movement sensors 30), to detect a downward slope on or at an end of upper roadway 22 toward which vehicle 14 is travelling in reverse. In some cases, negative slope detection module 48 may utilized data from navigation sensors 32 to calculate a distance of vehicle 14 from a known (e.g., mapped on a local or global coordinate system) location of cliff 24 or another downward slope.

Such a detected downward slope may indicated approaching cliff 24 (e.g., in the absence of a safety barrier 12), or the outer edge of safety barrier 12 that is adjacent to cliff 24. In some cases, a detected downward slope, or even a horizontal slope, may be indicative of an unsafe distance from cliff 24, e.g., where the weight of vehicle 14 may cause the ground to collapse or otherwise risk falling over cliff 24. Generally, a safe distance from cliff 24 may be indicated by an at least slightly upward slope.

Negative slope detection module 48 may calculate a distance between vehicle 14 and a detected cliff 24 or another detected downward slope. Negative slope detection module 48 may utilize the calculated distance, as well as data from movement sensors 30, to calculate a time when vehicle 14 will approach to within a predefined unsafe distance from detected cliff 24 or another detected downward slope. Similarly, negative slope detection module 48 may calculate a rate of approach of vehicle 14 toward detected cliff 24 or another detected downward slope. In some cases, negative slope detection module 48 (or another module that utilizes results of analysis by negative slope detection module 48) may calculate a predicted path of movement of based on data from movement sensors 30 (e.g., a detected current steering angle of vehicle 14 or other data).

If, when a current approach toward detected cliff 24 or another detected downward slope is determined by negative slope detection module 48 to be unsafe (e.g., too fast or too near), e.g., as compared with predefined safety criteria, negative slope detection module 48 may issue an alert. The alert may be conveyed to an operator of vehicle 14 via user interface 40 of onboard hazard detection system 16.

Results of operation of negative slope detection module 48, or of a module of onboard hazard detection system 16 that utilizes calculations of negative slope detection module 48, may be recorded in database 54. For example, the results may be incorporated into a map of the region, e.g., for utilization by a GNSS or other system.

Obstacle detection module 50 executing on processor 42 may apply algorithms or methods similar to those of map construction module 43, negative slope detection module 48, or other methods to detect an obstacle 23 on upper roadway 22. Obstacle detection module 50 may be configured to identify or classify a detected obstacle 23, e.g., by analysis of an image of obstacle 23 and comparison with a database of known types of obstacles 23.

Obstacle detection module 50 may calculate a distance between vehicle 14 and a detected obstacle 23. Obstacle detection module 50 may utilize the calculated distance, as well as data from movement sensors 30, to calculate a time when vehicle 14 will approach to within a predefined unsafe distance of obstacle 23. If obstacle detection module 50 detects that vehicle 14 is approaching obstacle 23, obstacle detection module 50 may be configured to issue an alert that may be conveyed to an operator of vehicle 14 via user interface 40.

Results of operation of obstacle detection module 50, or of a module of onboard hazard detection system 16 that utilizes calculations of obstacle detection module 50, may be recorded in database 54. For example, the results may be incorporated into a map of the region, e.g., for utilization by a GNSS or other system.

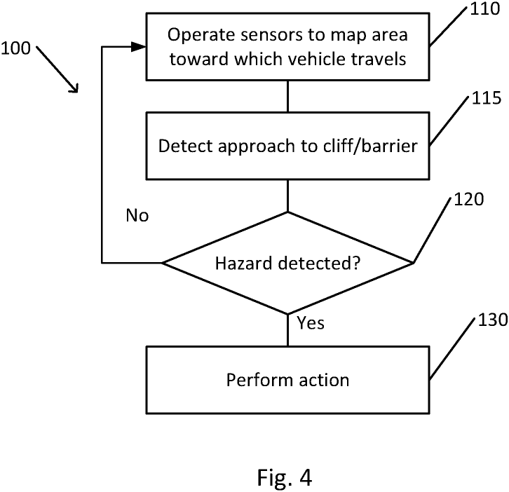

FIG. 4 is a flow chart depicting a method of operation of the hazard detection system illustrated in FIG. 2.

Execution of hazard detection method 100 is intended to monitor in real time the environment behind a vehicle 14, in particular when vehicle 14 is travelling in reverse toward a cliff 24.

Operations of hazard detection method 100 may be executed by a processor 42 of onboard hazard detection system 16 installed on a vehicle 14. Hazard detection method 100 may be executed automatically and continuously during operation of vehicle 14, may be executed only under predetermined conditions (e.g., travelling on an upper roadway 22 near the top of cliff 24, when being driven in reverse, or under other conditions), or may be initiated by an operator of vehicle 14.

It should be understood with respect to any flowchart referenced herein that the illustrated division of the method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Processor 42 of onboard hazard detection system 16 receives sensor data from one or more sensors of onboard hazard detection system 16 and analyzes the data to generate a three-dimensional map of a region toward which vehicle 14 is travelling, typically behind vehicle 14 (block 110). For example, the data may be received from mapping sensors 38, and sometimes from navigation sensors 32.

The received sensor data may be analyzed by at least a barrier detection module 46 operating on processor 42 to calculate characteristics of an approach of vehicle 14 toward a safety barrier 12 (block 120). For example, the characteristics may include a distance to safety barrier 12, an angle of approach to safety barrier 12, a time to impact or encounter with safety barrier 12, a speed of approach, a current route traveled by vehicle 14, or other characteristics.

In some cases, the calculated characteristics, or other analysis of sensor data (e.g., by negative slope detection module 48 or by obstacle detection module 50) may indicate a hazard (block 120). For example, a hazard may include an unsafe speed or angle of approach toward safety barrier 12, a lack of a safety barrier 12 near cliff 24, a close approach to cliff 24, an obstacle 23, or another identified hazard.

If no hazard is detected, receiving of sensor data continues (block 110).

If a hazard is detected, processor 42 may perform an action (block 130). For example, the action may include issuing an alert or controlling operation of vehicle 14. An issued alert may be conveyed to an operator of vehicle 14 via a user interface 10. In some cases, one or more of the alert, data associated with the alert, or other data, may be recorded on a database. Controlling operation of vehicle 14, e.g., via an external system 56, may include, for example, operating a brake, a steering system, a gearshift, an engine, or another controllable component or system of vehicle 14.

Different embodiments are disclosed herein. Features of certain embodiments may be combined with features of other embodiments; thus, certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. An onboard hazard detection system for installing on a vehicle, the system comprising a processor that is configured to:
receive sensed data that is acquired by one or more sensors that are installed on the vehicle and that are configured to sense a topography of a region in the vicinity of the vehicle;
analyze the received data to:
generate a three-dimensional map of the region based on the sensed data;
calculate one or more characteristics of an approach of the vehicle toward a cliff or safety barrier, based on the sensed data; and
detect when the calculated characteristics are indicative of a hazard; and
when an indication of the hazard is detected, perform an action.

2. The system of claim 1, wherein the characteristics are selected from a group of characteristics consisting of: a speed of the vehicle toward the cliff or the safety barrier, an angle of approach of the vehicle toward the cliff or the safety barrier, a distance from the cliff or the safety barrier, and a time to impact with the cliff or the safety barrier.

3. The system of claim 1, wherein the processor is further configured to detect an obstacle based on the sensed data.

4. The system of claim 1, wherein the processor is configured to detect a defect in the safety barrier.

5. The system of claim 4, wherein the defect comprises an insufficient height of the barrier or an insufficient width of the barrier.

6. The system of claim 1, wherein the processor is further configured to receive sensed data from one or more movement sensors that are configured to sense a characteristic of movement of the vehicle.

7. The system of claim 6, wherein the processor is configured to generate the map using the data received from the one or more movement sensors.

8. The system of claim 1, wherein the processor is further configured to receive data from one or more navigation sensors.

9. The system of claim 8, wherein the processor is configured to analyze the received sensed data only when the vehicle is within a predefined geographic region as indicated by the one or more navigation sensors.

10. The system of claim 1, wherein the processor is configured to analyze the sensed data only when the vehicle is travelling in reverse.

11. The system of claim 1, wherein the hazard is selected from a group of hazards consisting of: an unsafe speed of the approach, an unsafe angle of the approach, a defect in the safety barrier, an unsafe distance from the cliff, an unsafe distance from a downward slope, a negative slope in a surface, and presence of an obstacle.

12. The system of claim 1, wherein the action comprises issuing a warning or controlling operation of the vehicle.

13. A method of operation of an onboard hazard detection system installed on a vehicle, the method comprising:
operating one or more mapping sensors that are installed on the vehicle and that are configured to sense a topography of a region in the vicinity of the vehicle;
receiving sensed data that is acquired by the one or more mapping sensors;
generating a three-dimensional map of the region based on the sensed data;
calculating one or more characteristics of an approach of the vehicle toward a cliff or safety barrier, based on the sensed data;
detecting when the calculated characteristics are indicative of hazard; and
when an indication of the hazard is detected, performing an action.

14. The method of claim 13, further comprising detecting an obstacle based on the sensed data.

15. The method of claim 13,further comprising detecting a defect in the safety barrier.

16. The method of claim 13, further comprising receiving sensed data from one or more movement sensors that are configured to sense a characteristic of movement of the vehicle.

17. The method of claim 16, wherein generating the map further comprises using the data received from the one or more movement sensors.

18. The method of claim 13, further comprising receiving data from one or more navigation sensors.

19. The method of claim 13, wherein the characteristics are selected from a group of characteristics consisting of: a speed of the vehicle toward the cliff or the safety barrier, an angle of approach of the vehicle toward the cliff or the safety barrier, a distance from the cliff or the safety barrier, and a time to impact with the cliff or the safety barrier.

20. The method of claim 13, wherein the hazard is selected from a group of hazards consisting of: an unsafe speed of the approach, an unsafe angle of the approach, a defect in the safety barrier, an unsafe distance from the cliff, an unsafe distance from a downward slope, a negative slope in a surface, and presence of an obstacle.

21. The method of claim 13, wherein performing the action comprises issuing a warning or controlling operation of the vehicle.
